(19) United States
(12) Patent Application Publication
(10) Pub. No.: US 2026/0100306 A1
(43) Pub. Date: Apr. 9, 2026

(54) COIL COMPONENT

(71) Applicant: SAMSUNG ELECTRO-MECHANICS CO., LTD., Suwon-si (KR)

(72) Inventors: Joung Hee CHO, Suwon-si (KR); Dong Gun LEE, Suwon-si (KR); Dong Hwi AHN, Suwon-si (KR)

(73) Assignee: SAMSUNG ELECTRO-MECHANICS CO., LTD., Suwon-si (KR)

(21) Appl. No.: 19/220,848

(22) Filed: May 28, 2025

(30) Foreign Application Priority Data
Oct. 8, 2024 (KR) 10-2024-0136236

(51) Int. Cl. H01F 27/28; H01F 27/29

(52) U.S. Cl. CPC H01F 27/2828; H01F 27/292

(57) ABSTRACT

A coil component includes a body having first and second side surfaces opposing each other in a first direction and third and fourth side surfaces opposing each other in a second direction. The body includes a magnetic material. A coil is disposed within the body, and a lead frame is connected to an end of the coil. The lead frame includes a side-surface portion positioned on the first and second side surfaces of the body and at least one extension portion extending outward from the side-surface portion in the second direction, protruding outward from the body. The extension portion may be formed by bending or cutting a portion of the lead frame, providing improved adhesion strength and vibration resistance when mounted on a substrate.

### CROSS-REFERENCE TO RELATED APPLICATION(S)

This application claims the benefit of priority to Korean Patent Application No. 10-2024-0136236 filed on Oct. 8, 2024 in the Korean Intellectual Property Office, the disclosure of which is incorporated herein by reference in its entirety.

### BACKGROUND

### 1. Field

The present disclosure relates to a coil component.

### 2. Description of Related Art

An inductor, a coil component, may be a representative passive electronic component in an electronic device along with a resistor and a capacitor.

Recently, the market for a power inductor for high current such as AI, automotive electronics, and robotics has increased, and in particular, automotive electronic components may require high-reliability technology to enhance safety and may need to meet high-current properties while also ensuring resistance to vibrations.

### SUMMARY

An aspect of the present disclosure is to provide a coil component having improved resistance to vibrations and enhanced adhesive strength when mounted on a substrate.

According to an aspect of the present disclosure, a coil component includes a body including first and second side surfaces opposing each other in a first direction, third and fourth side surfaces opposing each other in a second direction, and including a magnetic material; a coil disposed in the body; and a lead frame connected to an end of the coil, wherein the lead frame includes a side-surface portion disposed on the first side surface and the second side surface of the body, and at least one extension portion outside the side-surface portion with respect to the second direction and protruding outwardly of the body.

According to an aspect of the present disclosure, a coil component includes a body including first and second side surfaces opposing each other in a first direction, third and fourth side surfaces opposing each other in a second direction, and including a magnetic material; a coil disposed in the body; and a lead frame connected to an end of the coil, wherein the lead frame includes a lower-surface portion disposed on a lower surface of the body, and at least one extension portion connected to the lower-surface portion and protruding outwardly from the body, and wherein a length in the second direction of the lower-surface portion is greater than a length in the second direction of the extension portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to an embodiment of the present disclosure;

FIG. 2 is a cross-sectional diagram taken along line I-I′ in FIG. 1;

FIG. 3 is a diagram illustrating a lead frame illustrated in FIG. 1;

FIG. 4 is a diagram illustrating the example illustrated in FIG. 1, viewed in the second direction;

FIG. 5 is a diagram illustrating the example illustrated in FIG. 1, viewed in the third direction;

FIG. 6 is a diagram illustrating a coil of a coil component and a lead frame before bending according to an embodiment of the present disclosure;

FIGS. 7A and 7B are perspective diagrams illustrating modified examples according to an embodiment of the present disclosure;

FIG. 8 is a perspective diagram illustrating a coil component according to another embodiment of the present disclosure; and

FIG. 9 is a diagram illustrating a coil of a coil component and a lead frame before bending according to another embodiment of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An term used in the singular encompasses the term of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the term that an element is disposed “on” may indicate that the element may be disposed above or below a target portion and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the X-direction may be defined as a first direction or a length direction, the Y-direction may be defined as a second direction or a width direction, and the Z-direction may be defined as a third direction or a thickness direction.

In the drawings, the same elements will be indicated by the same reference numerals. Also, redundant descriptions and detailed descriptions of known functions and elements which may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, an HF inductor, a general bead, a GHz bead, a common mode filter, or the like.

### First Embodiment

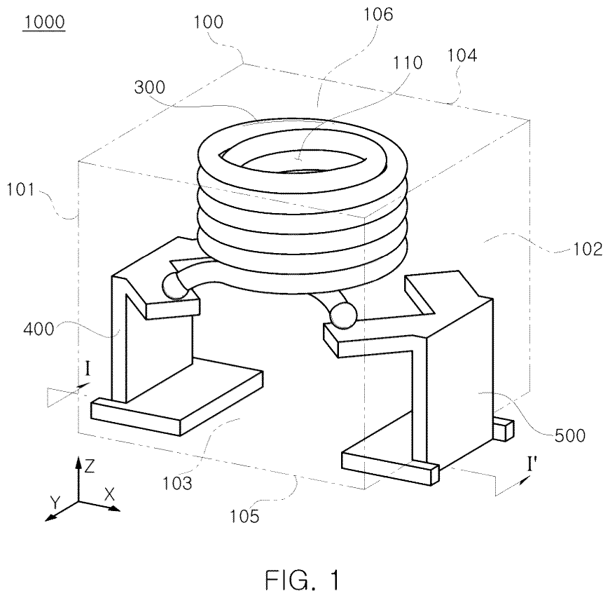

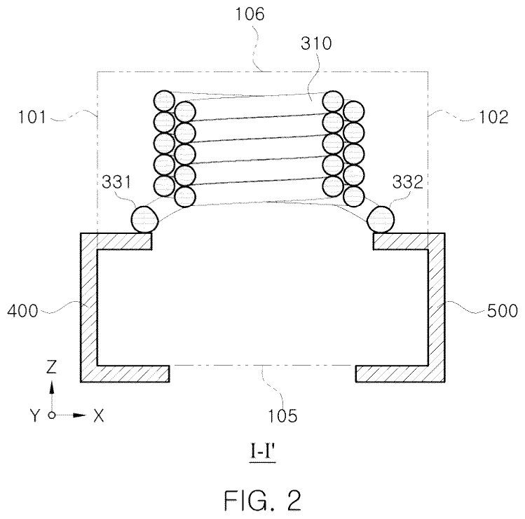

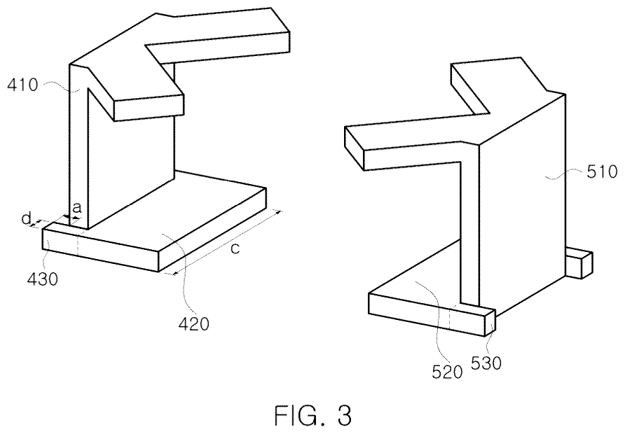

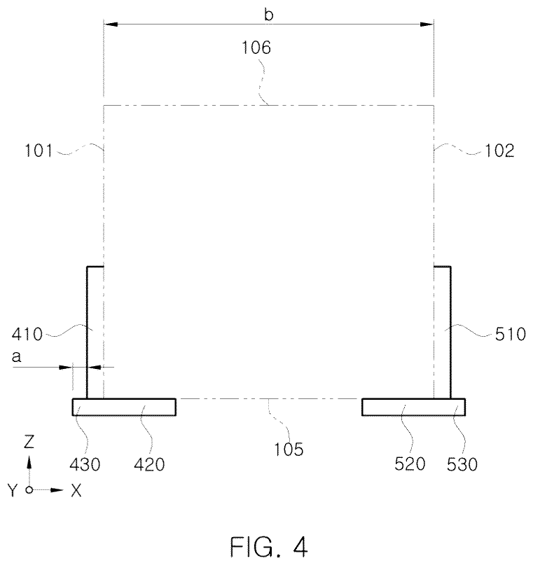

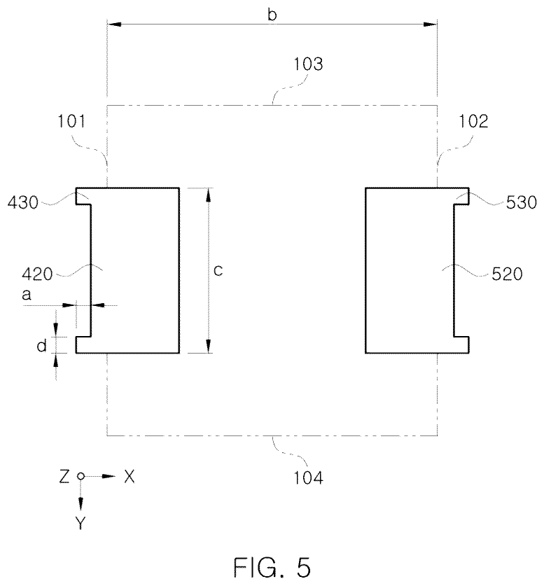

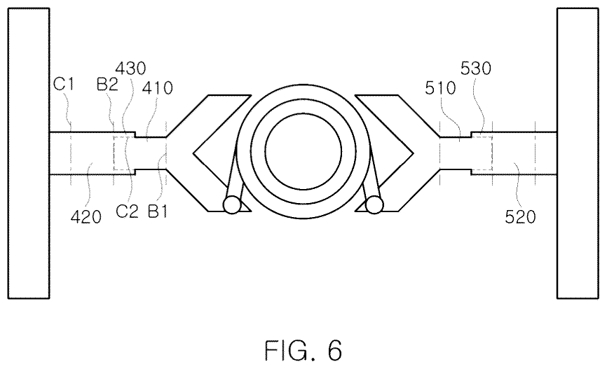

FIG. 1 is a perspective diagram illustrating a coil component according to an embodiment. FIG. 2 is a cross-sectional diagram taken along line I-I′ in FIG. 1. FIG. 3 is a diagram illustrating a lead frame illustrated in FIG. 1. FIG. 4 is a diagram illustrating the example illustrated in FIG. 1, viewed in the second direction. FIG. 5 is a diagram illustrating the example illustrated in FIG. 1, viewed in the third direction. FIG. 6 is a diagram illustrating a coil of a coil component and a lead frame before bending according to an embodiment.

Referring to FIG. 1, a coil electronic component according to an embodiment may include a body 100 including a magnetic material, a coil 300 disposed in the body 100, and lead frames 400 and 500 extending to a side surface of the body.

The body 100 may form an overall exterior of the coil component 1000 in the embodiment, and the support member 200 and the coil 300 may be embedded therein.

The body 100 may have a hexahedral shape. Referring to FIG. 1, the body 100 may include a first side surface 101 and a second side surface 102 opposing each other in the first direction (X-direction), a third side surface 103 and a fourth side surface 104 opposing each other in the second direction (Y-direction), and a fifth side surface 105 and a sixth side surface 106 opposing each other in the third direction (Z-direction). The first to fourth side surfaces 101, 102, 103, and 104 of the body 100 may be side surfaces of the body 100 connecting the lower surface 105 to the upper surface 106 of the body 100.

The body 100 may include a magnetic material. The body 100 may be formed by filling a mold with a magnetic material, and may be formed by filling a composite material including a magnetic material and an insulating resin into the mold. A molding process of applying high temperature and high pressure to the magnetic material or the composite material in the mold may be further performed, but an example embodiment thereof is not limited thereto.

The magnetic material included in the body 100 may be ferrite or a metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

The metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be an Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape. For example, the body 100 may include two or more magnetic powders having different average diameters.

The insulating resin may include epoxy, polyimide, a liquid crystal polymer, or the like, alone or in combination but an embodiment thereof is not limited thereto.

The body 100 may include the core 110. The core 110 may refer to a portion of the body 100 penetrating the coil 300 described below. The core 110 may be disposed in an inner region of the coil 300 forming at least one turn, and the cross-section may have a circular or elliptical shape.

The coil 300 may be disposed in the body 100 and may exhibit characteristics of the coil component. For example, when the coil component 1000 according to the embodiment is used as a power inductor, the coil 300 may store an electric field as a magnetic field and may maintain an output voltage, thereby stabilizing power of the electronic device.

The coil 300 may include a winding portion 310 forming at least one turn with respect to the core 110 and lead-out portions 331 and 332 connected to a winding portion and a lead frame described below.

Referring to FIG. 1 and FIG. 2, the winding portion 310 may form a plurality of turns toward an external side of the body 100 in the first direction (X-direction) and the second direction (Y-direction) of the body 100 from the core 110. The winding portion 310 may be disposed in parallel to the body lower surface 105, and a winding axis of the winding portion 310 may be formed in parallel to the third direction (Z-direction).

The winding portion 310 may be wound in a circular or elliptical shape, and the core 110 may be disposed in a center.

The first and second lead-out portions 331 and 332 may correspond to both ends of the coil 300 and may be connected to the lead frames 400 and 500 in the body 100. That is, in FIG. 2, the first lead-out portion 331 may be connected to the first lead frame 400, and the second lead-out portion 332 may be connected to the second lead frame 500.

The coil 300 may be configured as a hollow coil, may include a metal wire MW having a circular cross-section, and may also include a flat coil, but an example embodiment thereof is not limited thereto.

The coil 300 may be formed by winding a conductive metal, and the portions other than the portions in contact with the lead frames 400 and 500 described below may be coated with an insulating coating layer. Specifically, the coil 300 may be formed by winding a metal wire MW such as a copper wire (Cu-wire) including a metal wire and an insulating coating layer covering the surface of the metal wire into a spiral shape.

The lead frames 400 and 500 may be connected to ends of the coil 300 and may be disposed on side surfaces 101 and 102 and a lower surface 105 of the body and may work as an external electrode of the coil component according to an embodiment.

Referring to FIG. 2, the lead frames 400 and 500 may include a first lead frame 400 disposed on the first side surface 101 of the body 100 and a second lead frame 500 disposed on the second side surface 102 of the body 100. The first lead frame 400 may be connected to the first lead-out portion 331 in the body 100, and the second lead frame 500 may be connected to the second lead-out portion 332 in the body 100.

Hereinafter, the first lead frame 400 will be described below, and the same description may be applied to the second lead frame 500, and detailed descriptions may overlap, and thus, the description of the second lead frame 500 may not be provided.

Referring to FIGS. 3 to 5, the first lead frames 400 and 500 may include a side-surface portion 410 disposed on the first side surface 101, a lower-surface portion 420 disposed on the body lower surface 105, and at least one extension portion 430 protruding outwardly of the body 100.

The first lead frame 400 may be configured to be disposed on the first side surface 101 of the body 100 and may be bent to the lower surface. Specifically, the first lead frame 400 may extend from an internal portion of the body 100 to the first side surface 101 and may be connected to the body lower surface 105 along the side-surface portion 410 disposed on the first side surface 101.

That is, the first lead frame 400 may include a side-surface portion 410 disposed on the first side surface 101 of the body and a lower-surface portion 420 connected to the side-surface portion and disposed on the lower surface 105 of the body.

The lower-surface portion 420 disposed on the lower surface 105 of the body 100 may be provided as an electrode surface connected to the substrate when the substrate is mounted.

The lead frame of the general coil component may have a ‘C’-shaped structure and may be vulnerable to vibration. In particular, when vibrating in the second direction (Y direction), the bent portion (the boundary of the side-surface portion and the lower-surface portion) may be particularly vulnerable to vibration, and a structure to compensate therefor may be suggested.

The coil component 1000 according to the embodiment may be configured to have at least one extension portion 430 protruding outwardly of the body 100. The extension portion 430 may protrude toward the external side of the body in the first direction (X direction). By forming at least one extension portion 430 in the lead frame 400, a soldering area on the substrate may be increased, thereby ensuring stability of the coil component against vibration.

The extension portion 430 may extend from the lower-surface portion 420 and may be disposed on the external side of the side-surface portion 410 in the second direction (Y direction).

The side surface of the extension portion 430 may include a cut surface, and the extension portion 430 may be separated from the side-surface portion 410 of the lead frame along the cut surface. That is, the extension portion 430 and the side-surface portion 410 may be connected to the lower-surface portion 420, and the extension portion 430 and the side-surface portion 410 may be divided along the cut surface.

The side-surface portion 410 may be separated along the cut surface and may be disposed on the side surfaces 101 and 102 of the body by being bent from the lower-surface portion 420.

The extension portion 430 may be separated along the cut surface and, together with the lower-surface portion 420, and may be provided as an electrode surface when mounting a substrate.

The extension portion 430 may be a portion of the lead frame 400 extending from the lower-surface portion 420, and may thus be positioned at a level lower than a level of the first side surface 101 of the body 100. The extension portion 430 may be integrated with the lower-surface portion 420.

A portion of the extension portion 430 may protrude further from the first side surface 101 than the side-surface portion 410. In this case, when a length protruding further than the side-surface portion of the extension portion 430, from the first side surface of the body, is defined as a, and the length in the first direction (X-direction) of the body 100 is defined as b, a/b may satisfy 0 greater than 0 and 0.065 or lower. When a/b exceeds 0.065, the length in the first direction of the coil component including the lead frame may increase excessively, which may be detrimental to miniaturization of component.

The length in the second direction (Y-direction) of the lower-surface portion 420 may be greater than the length in the second direction (Y-direction) of the extension portion 430. The length in the second direction (Y-direction) of the lower-surface portion 420 may be greater than the length in the second direction (Y-direction) of the side-surface portion 410. As described above, since the side-surface portion 410 and the extension portion 430 are divided with respect to the cross-sectional surface, a sum of their lengths in the second direction of the side-surface portion 410 and the extension portion 430 may be equal to the length in the second direction of the lower-surface portion 420.

When the length of the lower-surface portion 420 in the second direction (Y-direction) is defined as c and the length of the extension portion 430 in the second direction (Y-direction) is defined as d, d/c may satisfy 0 to 0.083 or lower. When d/c exceeds 0.083, the width of the extension portion 430 may be excessively enlarged, and the width of the side-surface portion 410 may be relatively reduced, and the lead frame side-surface portion may become vulnerable to vibration.

A plurality of the extension portion 430 may be formed. Referring to FIGS. 3 and 5, a plurality of the extension portion 430 may be formed on the first lead frame 400 and may be spaced apart from each other in the second direction (Y-direction) with the side-surface portion 410 interposed therebetween. The plurality of extension portions 430 may be disposed on both ends of the lower-surface portion 420 in the second direction (Y-direction). By forming the plurality of extension portions 430 to be spaced apart from in the second direction (Y-direction), vibration stability of the coil component may be assured when vibrating in the second direction (Y-direction).

The distance at which the plurality of extension portions 430 are spaced apart from in the second direction (Y-direction) may be the same as the length of the side-surface portion 410 in the second direction (Y-direction). The distance at which the plurality of extension portions 430 are spaced apart from in the second direction (Y-direction) may be smaller than the length of the lower-surface portion 420 in the second direction (Y-direction).

The length of the lower-surface portion 420 in the second direction (Y-direction) may be larger than the length of the side-surface portion 410 in the second direction (Y-direction). As described above, since the extension portion 430 and the side-surface portion 410 are connected to the lower-surface portion 420, and the extension portion 430 and the side-surface portion 410 are divided with respect to the cross-sectional surface, the width (length in the second direction) of the lower-surface portion 420 may be greater than the width (length in the second direction) of the side-surface portion 410.

FIG. 6 is a diagram illustrating a coil of a coil component and a lead frame before bending according to an embodiment.

As an initial form of the frame, the lower-surface portion 420, the side-surface portion 410, and the extension portion 430 may be connected to each other. In order to process the frame in the form of a lead frame, the frame may be cut along C1, and the side-surface portion 410 and the extension portion 430 may be cut along C2. Thereafter, the frame may be bent along B1 such that the side-surface portion 410 may be disposed on the side surface of the body, and the frame may be bent along B2 such that the lower-surface portion 420 may be disposed on the lower-surface portion of the body. In this case, the extension portion 430 may be bent together with the lower-surface portion 420 and may form a lower surface electrode. That is, with respect to C2, the side-surface portion 410 may be disposed on the side surface of the body, and the extension portion 430 may be positioned at a level lower than a level of the body together with the lower-surface portion 420.

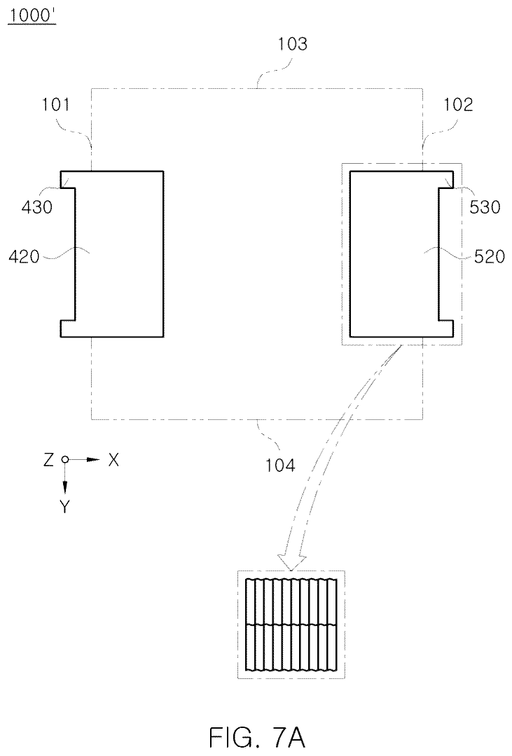

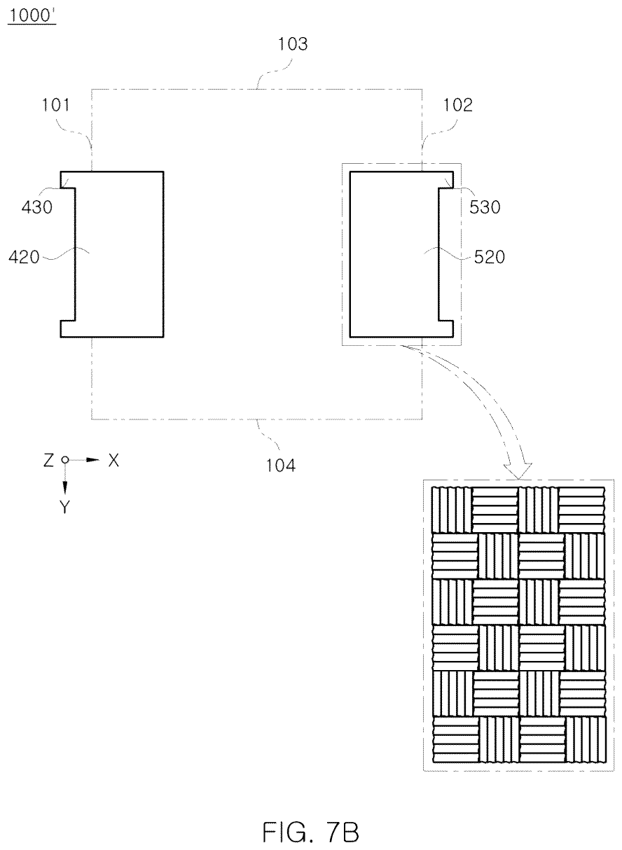

FIGS. 7A and 7B are perspective diagrams illustrating modified examples according to an embodiment.

Referring to FIGS. 7A and 7B, a coil component 1000′ according to the modified example may include a plurality of slit-shaped recesses extending in the second direction (Y-direction) on a bottom surface of the lower-surface portion 420.

A plurality of recesses may be spaced apart from each other in the first direction (X-direction).

That is, the coil component 1000′ according to the modified example may increase a mounting contact area with the substrate when mounting the substrate by bending or deforming the lower-surface portion 420, and may ensure vibration stability.

As in FIG. 7A, recesses extending in the second direction (Y-direction) may be disposed continuously, or as in FIG. 7B, the recesses extending in the second direction (Y-direction) and the recesses extending in the first direction (X-direction) may be disposed alternately and repeatedly.

### Second Embodiment

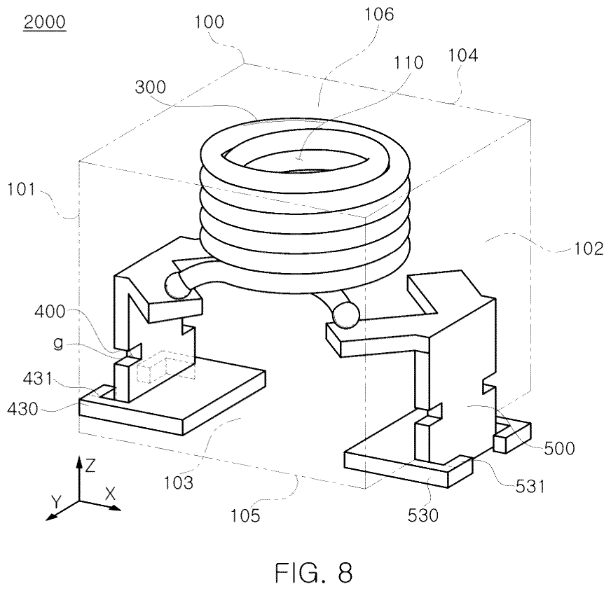

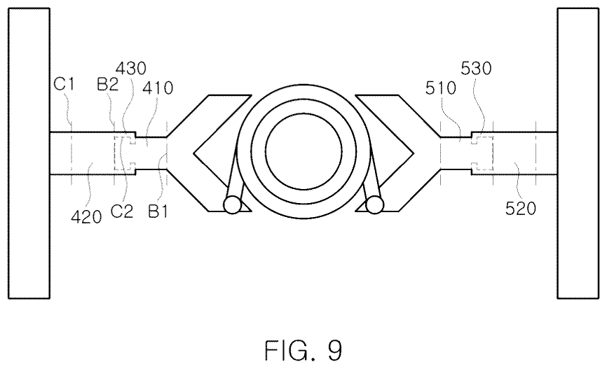

FIG. 8 is a perspective diagram illustrating a coil component according to another embodiment. FIG. 9 is a diagram illustrating a coil of a coil component and a lead frame before bending according to another embodiment.

The coil component 2000 according to FIG. 8 may include a protrusion 431 in which at least a portion of the extension portion 430 protrudes inwardly of the body 100 in the second direction (Y-direction).

Since the extension portion 430 includes a structure protruding inwardly of the body such as ‘¬,’ a mounting contact area of the component may be increased when mounting the substrate. Accordingly, vibration stability may be assured efficiently in the limited length of the extension portion 430.

A groove g of which a partial region is removed may be formed in the side-surface portion 410 to correspond to the protrusion 431′.

Referring to FIG. 9, when cutting the frame along C2, a portion of the side-surface portion 410 may be removed in order to form a protrusion of the extension portion compared to FIG. 6. The removed portion of the side-surface portion 410 may be formed by the groove g, and the protrusion of the extension portion may correspond to the groove g.

The description of other components overlaps the coil component according to the first embodiment, and a detailed description may not be provided.

According to the aforementioned embodiments, a coil component having improved resistance to vibration and enhanced adhesion strength when mounted on a substrate may be provided.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including first and second side surfaces opposing each other in a first direction, third and fourth side surfaces opposing each other in a second direction, and including a magnetic material;
a coil disposed in the body; and
a lead frame connected to an end of the coil,
wherein the lead frame includes a side-surface portion disposed on the first side surface and the second side surface of the body, and at least one extension portion disposed outside the side-surface portion with respect to the second direction and protruding outward from the body.

2. The coil component of claim 1, wherein at least a portion of the extension portion is positioned farther from a first side surface and a second side surface of the body than the side-surface portion.

3. The coil component of claim 2, wherein, when a length of the extension portion protruding farther outward from the first and second side surfaces of the body than the side-surface portion is defined as a, and a length in the first direction of the body is defined as b, wherein a ratio of a/b is greater than 0 and satisfies 0.065 or lower.

4. The coil component of claim 1, wherein at least a portion of the extension portion is positioned at a level lower than a level of the first and second side surfaces of the body.

5. The coil component of claim 1,
wherein a plurality of the extension portions are formed, and
wherein the plurality of extension portions are spaced apart from each other in the second direction with the side-surface portion interposed therebetween.

6. The coil component of claim 5, wherein a distance at which the plurality of extension portions are spaced apart from each other in the second direction is equal to a length of the side-surface portion in the second direction.

7. The coil component of claim 1,
wherein the lead frame further includes a lower-surface portion disposed on a lower surface of the body and connected to the side-surface portion, and
wherein the lower-surface portion is integrally formed with the extension portion.

8. The coil component of claim 7,
wherein a length in the second direction of the lower-surface portion is greater than a length in the second direction of the side-surface portion.

9. The coil component of claim 7,
wherein a bottom surface of the lower-surface portion includes a plurality of recesses having a slit shape extending in the second direction, and
wherein the plurality of recesses are spaced apart from each other in the first direction.

10. The coil component of claim 1, wherein the extension portion includes a protrusion having at least a portion extending inward into the body in the second direction.

11. The coil component of claim 10, wherein a groove of which a partial region is removed to correspond to the protrusion is formed in the side-surface portion.

12. A coil component, comprising:
a body including first and second side surfaces opposing each other in a first direction, third and fourth side surfaces opposing each other in a second direction, and including a magnetic material;
a coil disposed in the body; and
a lead frame connected to an end of the coil,
wherein the lead frame includes a lower-surface portion disposed on a lower surface of the body, and at least one extension portion connected to the lower-surface portion and protruding outwardly of the body, and
wherein a length of the lower-surface portion is greater than a length of the extension portion in the second direction.

13. The coil component of claim 12, wherein, when a length in the second direction of the lower-surface portion is defined as c, and a length in the second direction of the extension portion is defined as d, wherein a ratio defined as d/c is greater than 0 and satisfies 0.083 or lower.

14. The coil component of claim 12, wherein at least a portion of the extension portion is positioned at a level lower than a level of the first and second side surfaces of the body.

15. The coil component of claim 12,
wherein a plurality of the extension portions are formed, and
wherein the plurality of extension portions are disposed at opposite ends of the lower-surface portion along the second direction.

16. The coil component of claim 15, wherein a distance at which the plurality of extension portions are spaced apart from each other in the second direction is less than a length of the lower-surface portion in the second direction.

17. The coil component of claim 12, wherein a cut surface defines a boundary between the extension portion and the side-surface portion.
